(19) United States
(12) Patent Application Publication
(10) Pub. No.: US 2011/0028139 A1
(43) Pub. Date: Feb. 3, 2011

(54) MOBILE COMMUNICATION DEVICE CONTROL METHOD

(76) Inventor: Dennis Odom, Albuquerque, NM (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 12/534,657

(22) Filed: Aug. 3, 2009

(51) Int. Cl. H04M 3/00; H04W 24/00

(52) U.S. Cl. 455/418; 455/456.4

(57) ABSTRACT

A mobile communication device, including but not limited to cell phones and personal digital assistants, has one or more functions disabled when, from within the device, it is determined that the device is moving at a speed above a speed threshold. An internal application controls such devices from within the devices, especially for turning them off when their users are driving a vehicle.

### FIELD OF THE INVENTION

The present invention relates to controlling mobile communication devices. More specifically, the invention relates to internal applications for controlling such devices from within the devices, especially embedded applications for turning off these devices when their users are driving a vehicle.

### BACKGROUND OF THE INVENTION

Mobile communication devices that provide for wireless phone, text, email and other Internet communication are in wide use today. While enabling these types of communications can be beneficial, use of these mobile communication devices can also create hazardous situations. One example is when a cell phone is used by a driver of a car while he/she is operating the vehicle. Such use might distract the vehicle driver/cell phone user and thereby lead to accidents that harm or kill drivers, passengers and others in the vicinity of the vehicle.

Laws might be passed (some have been) to prohibit using mobile communication devices when they could pose hazards, and users might simply not use them in such situations; however, programming such devices to automatically stop functioning in potentially dangerous conditions might be more effective. Accordingly, there is the need for an adaptable, relatively simple way to disable a mobile communication device so it (or one or more functions thereof) cannot be used by someone operating a vehicle (e.g., car, truck, boat, airplane). There is also the need to provide for limited outbound communications that notify others of certain events (e.g., inoperability, deactivation, changes) related to this control of a mobile communication device.

### SUMMARY OF INVENTION

When used within a mobile communication device, the present invention adaptably and relatively simply automatically disables such device when the device is placed in a potentially hazardous mobile situation. In a particular implementation of the present invention, it turns off a mobile communication device in a vehicle moving above a speed threshold. The present invention also provides for outbound communications related to such automatic control.

One reason the present invention is relatively simple is that it is wholly contained within the mobile communication device it controls. The present invention is adaptable because, for example, the speed threshold can be changed. As another example, the control can be turned off when use is likely not hazardous (e.g., use in a passenger's mobile communication device instead of in the driver's). In the event of a change, an outbound communication notifying of the change is sent.

A mobile communication device control method in accordance with the present invention comprises automatically running a usage termination application in a user's mobile communication device for disabling the user's mobile communication device in response to a vehicle moving at a speed greater than a predetermined speed threshold. This includes: having the user's mobile communication device located in the vehicle, and maintaining the usage termination application solely within the user's mobile communication device such that the speed-responsive disabling of the user's mobile communication device occurs entirely within the existing operations of the mobile communication device alone with no communication of control instructions to or from a network service provider or other party outside the user's mobile communication device.

Running a usage termination application may further include: obtaining speed data from the user's mobile communication device; comparing the obtained speed data with the predetermined speed threshold; and turning the user's mobile communication device off when the obtained speed data is greater than the predetermined speed threshold. In a particular implementation of the present invention, this may be implemented by obtaining data related to the locations of the mobile communication device and turning the mobile communication device off in response to the obtained data representing speed of the vehicle greater than the predetermined speed threshold. This location data may come from a global positioning system interface of the mobile communication device; however, other location or speed data acquisition sources may be used in broader aspects of the present invention.

Running a usage termination application may further include entering a recipient's communication address into the user's mobile communication device and sending predetermined messages to the entered communication address in response to predetermined conditions detected by the usage termination application. Sending predetermined messages may include one or more of the following: detecting when a recipient's communication address is changed in the user's mobile communication device; detecting when the predetermined speed threshold is changed in the user's mobile communication device; detecting when running the usage termination application is terminated while the user's mobile communication device remains on; detecting when a global positioning system interface (or other source for speed determining data) is not enabled; detecting when running the usage termination application cannot determine speed of the vehicle; and detecting when running the usage termination application in the user's mobile communication device has started.

The present invention also provides a mobile communication device control method, comprising automatically disabling at least one communication function of a mobile communication device traveling at a speed greater than a speed threshold. Such automatic disabling includes: automatically determining in the mobile communication device, using a usage termination application stored wholly within the mobile communication device, the speed of the mobile communication device; automatically comparing in the mobile communication device, using the usage termination application, the determined speed of the mobile communication device to the speed threshold; and automatically disabling the at least one communication function, using the usage termination application, in response to the determined speed of the mobile communication device exceeding the speed threshold.

Specific to a the particular implementation of the present invention as used with a cell phone, the invention provides a method of turning a cell phone off when the cell phone is in a vehicle traveling at a speed greater than a speed threshold. A specific implementation of this statement of the present invention comprises: operating, solely within the cell phone, a usage termination application stored wholly within the cell phone; entering, by manipulating only the cell phone, user interface configuration options into the usage termination application; automatically determining in the cell phone, using the usage termination application, the speed of the vehicle; automatically comparing in the cell phone, using the usage termination application, the determined speed of the vehicle to the speed threshold; and automatically turning off from within the cell phone, using the usage termination application, the cell phone in response to the determined speed of the vehicle exceeding the speed threshold.

Automatically determining the speed of the device can occur using speed-defining data from inside or outside the device, such as one or more of the following, for example: using in the usage termination application location and time data from elsewhere in the device (within the device but from outside the usage termination application), using in the usage termination application speed data from elsewhere in the device, or using in the usage termination application speed-defining data from outside the device (e.g., location data from outside the device, wherein the location data relates to changes in location of the device).

Therefore from the foregoing, it is a general object of the present invention to provide novel and improved mobile communication device control methods. Other and further objects, features, definitions, and advantages of the present invention will be readily apparent to those skilled in the art when the following description of the preferred embodiments is read in conjunction with the accompanying drawings.

### BRIEF DESCRIPTION OF THE DRAWINGS

FIG. 1 is a block diagram representing a generic mobile communication device with which the present invention may be used.

FIG. 2 is a flow diagram of an application for implementing a preferred embodiment of the present invention.

FIGS. 3A-3D represent a BlackBerry Curve smartphone implementation of a mobile communication device using the present invention.

### DETAILED DESCRIPTION OF THE INVENTION

The present invention is a method that controls a mobile communication device when the mobile communication device moves faster than a speed threshold. This method includes automatically running a usage termination application in a user's mobile communication device to disable the user's mobile communication device in response to a vehicle, carrying the mobile communication device, moving at a speed greater than the speed threshold (which speed threshold is predetermined either by original setting in the usage termination application or by subsequent change(s) thereto). The usage termination application is stored wholly within the mobile communication device and operates solely within it. “Mobile communication device” encompasses all the types of mobile devices that enable users to have wireless access to phone, text, Internet, and/or email service. Non-limiting examples include cell phones and personal digital assistants (PDAs). Hand-held examples of these include: Palm Pilot, Palm Pre, Apple iPhone, Apple iPod touch, Google(Android) phone, and BlackBerry devices. “Application” as used in “usage termination application” can be implemented in any manner providing the specified functions/steps of the present invention. For example, this includes code originally embedded within the mobile communication device (OEM) and code that can be embedded aftermarket [e.g., downloadable (from the Internet or other media) “apps” for the mobile communication devices]. These can be in any suitable form, such as software, firmware, or application specific integrated circuits, for example. “Vehicle” encompasses any means of land, aquatic or air transportation that could be hazardous to operate while simultaneously using a mobile communication device. Non-limiting examples include bicycles, scooters, motorcycles, automobiles, trucks, jet skis, boats, planes.

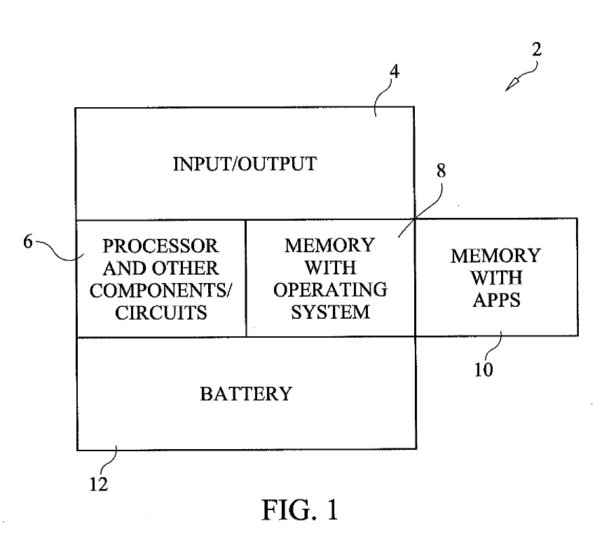

A generic mobile communication device 2 is represented by the block diagram of FIG. 1. Such mobile communication device 2 includes means 4 for providing input into and output from the device 2. One example of a discrete input means is a keyboard or keypad such as on a conventional cell phone, for example. One example of a discrete output means is a display screen, such as on a conventional cell phone, for example. Another example, that implements both input and output, is a touch screen, such as used in an Apple iPhone device, for example.

The mobile communication device 2 of FIG. 1 also includes, as represented by reference numeral 6, a processor (typically microprocessor) and other electronic operating circuits implemented with known types of discrete and integrated circuit components. These include electromagnetic wave transmitting and receiving components (e.g., oscillator, antenna, tuned filter) for providing the wireless link to the respective communication system with which the protocol of the mobile communication device works as known in the art.

Controlling the basic operation of the mobile communication device 2 is an operating system stored in a suitable memory 8 as represented in FIG. 1. Such operating systems and memory are known in the art—non-limiting examples include: Android, BlackBerry, Symbian, Palm, Windows Mobile.

In addition to the underlying operating system, the mobile communication device 2 typically has, as represented by reference numeral 10 in FIG. 1, one or more “apps” which are applications encoded to function in the respective operating system environment and to provide specific operational features to the mobile communication device 2. These may be originally stored in memory of the device 2 (OEM) or they may be added aftermarket (e.g., by downloading via the respective wireless system or by hardwired loading from a connected storage medium). When these apps are initially loaded, they may perform functions that enable them to work within particular operating systems in the mobile communication device (such as those mentioned above) and to work with particular service providers with which the mobile communication device works (e.g., AT&T, Verizon, Sprint, T-Mobile). Such interfacing may also cause the app to select for display certain options defined in the app to work with respective operating systems or service providers (e.g., providing only email addresses to be entered if texting is not available or acceptably implemented within certain systems). A preferred implementation of the present invention is as such an application/“app.” These types would typically be as “software,” but the present invention can be implemented using software, firmware, or application specific integrated circuits, for example.

The mobile communication device 2 is powered by a (typically rechargeable) battery 12 as known in the art.

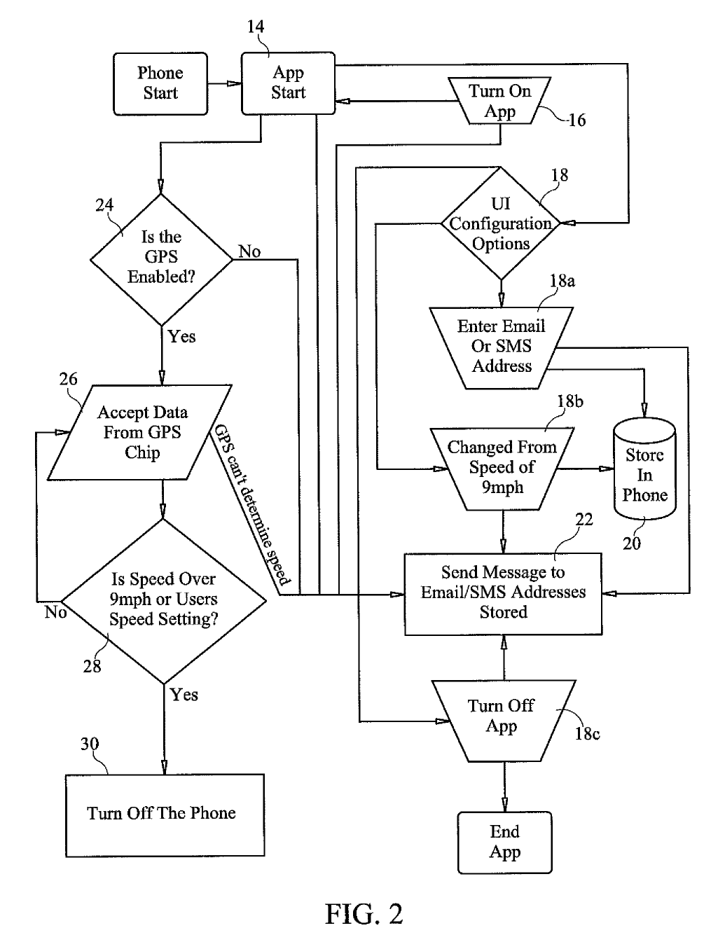

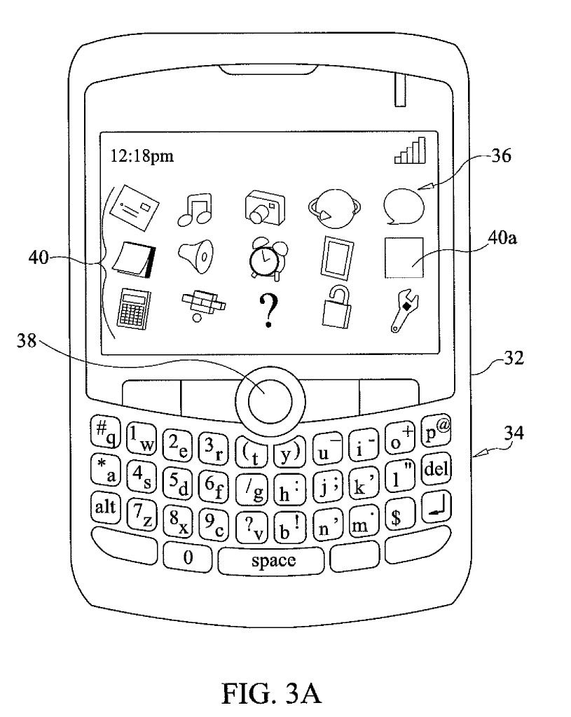

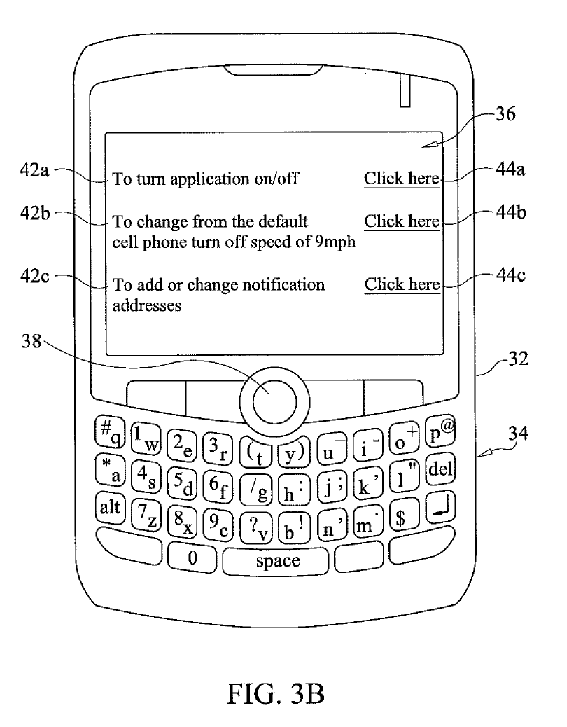

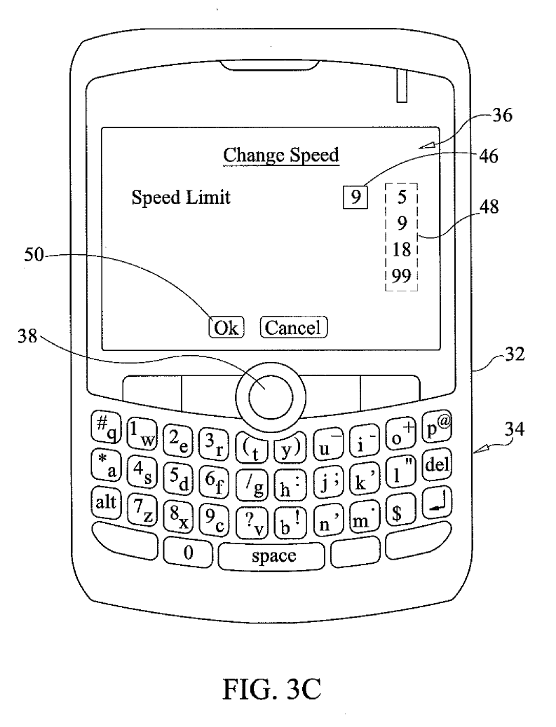

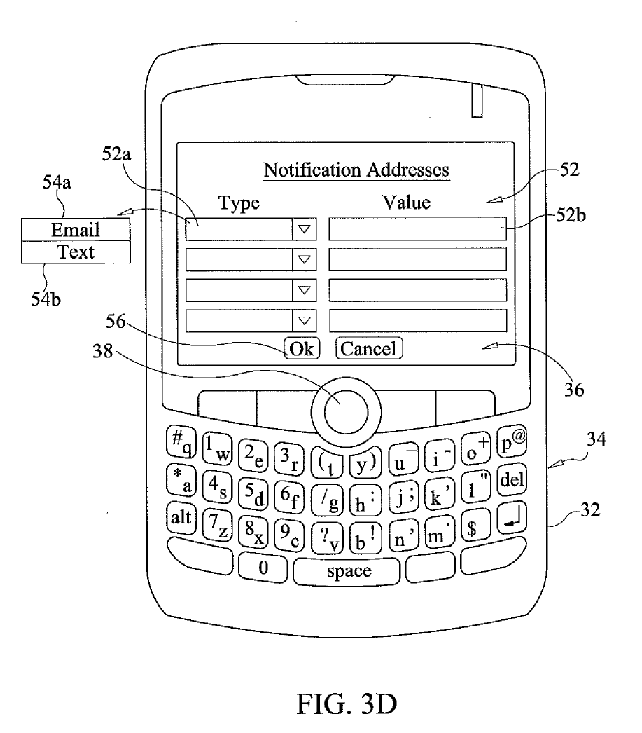

Regardless of the particular mobile communication device 2, the present invention provides a mobile communication device control method in which a usage termination application automatically runs in a user's mobile communication device for disabling the user's mobile communication device in response to detected movement at a speed greater than a speed threshold. Such detected movement typically occurs by having the user's mobile communication device located in a vehicle. The usage termination application is maintained solely within the user's mobile communication device such that the speed-responsive disabling of the user's mobile communication device occurs entirely within the existing operations of the mobile communication device alone such that there is no communication of control instructions to or from a network service provider or other party outside the user's mobile communication device. This will be described in more detail with reference to FIGS. 2 and 3.

A particular implementation of the control method of the present invention depicted in FIG. 2 uses an application for a smartphone type of cell phone that turns off the phone when the phone user is driving at a speed above the speed threshold. While a specific speed threshold is not limiting of the present invention, the threshold is preferably low enough to turn the phone off before too hazardous of a speed is reached and yet not so low as to occur in other moving situations, such as walking or jogging. One such speed threshold is nine miles per hour, which is greater than typical walking or jogging speeds of 3-7 miles per hour but hopefully low enough to prevent an accident when driving a car or other vehicle at such threshold speed.

In the FIG. 2 embodiment, when the phone is turned on the application of the present invention preferably automatically becomes active, as indicated at 14. Sometimes, however, the usage termination application must be manually activated, as indicated at 16. For example, the phone may be programmed to run other applications before getting to the usage termination application of the present invention (for example, the phone might only allow one third party application to run at any time, and there might be an application of such importance that it should have priority to run at start up); such situation can be overridden by manually activating the present invention via action 16. As another example, as explained below the usage termination application of the FIG. 2 embodiment can be manually turned off and so the application can be turned back on via action 16.

Once the usage termination application is installed, there are user interface (UI) configuration options 18 that can be selected. In the FIG. 2 implementation, email and text message (SMS) addresses can be entered as indicated at option 18a. These are stored in the phone's memory (action 20) and a message is sent to those addressees (action 22) when a change is made (e.g., “address changed from [original address] to [new address]”). These are examples of steps of entering a recipient's communication address into the user's mobile communication device and sending predetermined messages to the entered communication address in response to predetermined conditions detected by the usage termination application. In this example, sending predetermined messages includes detecting when an existing recipient's communication address is changed in the user's mobile communication device. The number of addresses that can be programmed is not a limitation of the present invention, but typically only a limited number need to be used (e.g., up to four addresses, such as an email address and cell phone/texting phone number “address” for each of two parents).

In the FIG. 2 implementation another option is to change the speed threshold as indicated at 18b. This change is stored in the phone's memory (see 20 in FIG. 2) and email or text messages are sent (see 22 in FIG. 2) according to the addresses entered at option 18a (e.g., “speed changed from [original speed] to [new speed]). Thus, sending predetermined messages includes detecting when the predetermined speed threshold is changed in the user's mobile communication device.

An option 18c of the implementation of FIG. 2 includes manually turning the usage termination application off even while the phone is still on. This option is provided so that, for example, a passenger having a phone programmed to perform the present invention can turn his/her phone's usage termination application off since he/she is not driving. As with the previous options, messages are sent when the application is turned off (see 22 in FIG. 2); therefore, in this case sending predetermined messages includes detecting when running the usage termination application is terminated while the user's mobile communication device remains on. A non-limiting example of a message to be sent to the addressees entered at 18a in FIG. 2 is in this case “phone control has been turned off.”

Once email and text messaging addresses have been entered and any change to the speed threshold made, the present invention monitors the speed of movement with which the phone is associated and the phone is turned off if the speed exceeds the speed threshold. In the FIG. 2 implementation speed is determined using global positioning system (GPS) data obtained through known functions of the phone outside of the usage termination application of the present invention. First, the usage termination application determines if the GPS capability of the phone is enabled, as indicated at 24 in FIG. 2. Detecting that the global positioning system interface in the user's mobile communication device is not enabled causes a message to be sent to the email and text messaging addresses (e.g., “GPS is not active”) (see 22 in FIG. 2). So this is another aspect of the FIG. 2 embodiment for sending predetermined messages to the addressees.

If the GPS interface is enabled, the present invention retrieves GPS data with which the usage termination application tries to determine the speed at which the phone is moving, as represented at 26 in FIG. 2. If the speed cannot be determined, a predetermined message is sent to the email and text messaging addresses (e.g., “GPS is not active”). So, sending predetermined messages includes detecting when running the usage termination application cannot determine speed of the vehicle.

If the speed is determined, it is compared to the speed threshold, as indicated at 28 in FIG. 2. If the speed does not exceed the speed threshold, the usage termination application continually repeats the monitoring until the phone is turned off or the threshold is exceeded. If the speed is determined and it exceeds the speed threshold, the usage termination application turns the phone off as indicated at 30 in FIG. 2. When the phone is turned back on, the usage termination application again becomes active and the process of the present invention is again performed. Whenever the usage termination application is started and there are previously stored email or text messaging addresses via option 18a, a predetermined message (e.g., “phone control is on”) is sent to those addresses upon detecting when running the usage termination application in the user's mobile communication device has started.

From the foregoing it is apparent that the present invention includes obtaining speed data from the user's mobile communication device; comparing the obtained speed data with the predetermined speed threshold; and turning the user's mobile communication device off when the obtained speed data is greater than the predetermined speed threshold. The usage termination application of the embodiment represented in FIG. 2 monitors speed of travel by calculating speed periodically (such as once per minute) when the phone is on. It does this in the FIG. 2 embodiment by obtaining data from a global positioning system interface of the user's mobile communication device. For example this can be done by obtaining GPS location data at the beginning and end of a time period (e.g, 60 seconds) and dividing the distance between those locations by the time elapsed between those most recent GPS locations. Example:

GPS point A is 1000 feet from GPS point B

GPS point A occurred 60 seconds before GPS point B occurs

1000 feet/60 seconds=16.67 feet/second

This speed is compared to the speed threshold (e.g., speed threshold of 9 miles/hour=13.20 feet/second) and because 16.67 feet/second is greater than 13.20 feet/second, the phone is turned off.

Although the above example uses GPS data, broader aspects of the present invention are not limited to UPS data acquisition. That is, location or direct speed data can be obtained in any suitable manner. For example, location fixes can be obtained using known techniques referred to as “cellsite” and “assisted.” The cellsite technique uses cellsite towers that attempt to provide triangulated location information, and assisted fixes come from using the service provider network in an assisted search known in the art. Another type of fix, known as an “autonomous” fix, uses the GPS chip on the mobile communication device. There also are known speed determining functions and location determining functions in phone development kits from phone manufacturers and operating system developers, for example, that may be used. Tools provided by phone operating systems (software developer kits/tools) may also provide known pre-programmed methods of determining speed. If these are available, the present invention may simply access the speed data directly rather than having to calculate speed through location and time data. Thus, automatically determining the speed of the vehicle includes, for example: receiving into the usage termination application speed-defining data obtained from within the cell phone but from outside the usage termination application, or receiving into the usage termination application speed-defining data obtained from outside the cell phone, or receiving global positioning system data into the usage termination application. Any of such location, time, or speed data retrieved into the usage termination application of the present invention from elsewhere in the mobile communication device (i.e., outside of the usage termination application itself), or outside the mobile communication device itself, is simply data and not external control instructions.

Other than the entering of user interface configuration options (e.g., 18a-18c in FIG. 2), which the user manually enters through input means of the mobile communication device, the control provided by the usage termination application preferably operates automatically (i.e., without user control but instead under operation of the mobile communication device itself) when the application is running.

Referring to FIGS. 3A-3D, more specific features of a mobile communication device are represented. This embodiment illustrates features of a BlackBerry Curve smartphone 32, which is one particular (but not limiting) implementation of a mobile communication device with which the present invention can be used. As known in the art, the phone 32 includes a keyboard/keypad 34, a screen 36, and a roller ball 38 that enables mouse-like control for making on-screen selections.

FIG. 3A represents the BlackBerry mobile communication device 32 displaying on the screen 36 icons 40 of the various applications (“apps”) that the user can select. In the present case, assume the application according to the present invention is represented by folder icon 40a. To select it, the user manipulates the roller ball 38 to move the on-screen indicator (e.g., cursor, highlighting) onto the folder icon 40a and then the user presses the roller ball 38 to select the application and initiate its operation. Alternatively, the application may be selected through one or more menus containing a list of the available apps, the desired one of which is selected in known manner through user operation of the roller ball 38 or keypad 34.

When the application used in implementing the present invention is selected, the screen selections 42a, 42b, 42c are shown on the screen 36 as represented in FIG. 3B (other information can be displayed as well, such as program name and time; however, such display of information is not part of the inventive method of the present invention). The user operates the roller ball 38 to move the roller ball indicator to one of the choices and presses the roller ball 38 to make the selection. The result of choosing selection 42a will be described with continuing reference to FIG. 3B, the result of choosing selection 42b will be described with reference to FIG. 3C, and the result of choosing selection 42c will be described with reference to FIG. 3D).

Still referring to FIG. 3B, the screen display changes when the user selects “click here” location 44a to turn the application on or off (selection is made by the user operating the roller ball 38 to move the roller ball indicator to the “click here” location 44a of the screen and then pressing the roller ball 38). That is, if the application is on and this “click here” option is selected, the screen selection changes to “To turn application on” and the application is otherwise turned off from providing the control of the present invention. So, to turn the application back on, the same “click here” location 44a is selected (in the same manner as described above) and the display toggles to show “To turn application off.” These thereby are used in implementing functions 16 and 18c, respectively, in FIG. 2. These also cause the appropriate message to be sent automatically as represented at 22 in FIG. 2.

Referring to FIG. 3C, when the user selects (using the roller ball 38) “click here” location 44b in FIG. 3B to select “To change from the default cell phone turn off speed of 9mph” the screen 36 displays the current speed setting as indicated at 46. The user manipulates the roller ball 38 to move the roller ball indicator to the current speed setting 46 and presses the roller ball 38. This causes alternative speed selection list 48 to appear on the screen 36 as also indicated in FIG. 3C. The user then operates the roller ball 38 to move the roller ball indicator to the desired speed and then the user presses the roller ball 38 whereupon the selected speed appears at 46 as the new predetermined speed setting. The roller ball indicator is moved to the “OK” button 50 shown on the screen 36 and the roller ball 38 is pressed to establish the new speed threshold and to send the messages in accordance with 18b, 20 and 22 shown in FIG. 2.

Referring to FIG. 3D, when the user selects (using the roller ball 38) “click here” location 44c in FIG. 3B to select “To add or change notification addresses” the screen 36 displays data entry places 52. The user operates the roller ball 38 to move the roller ball indicator to the first box 52a under “type” and then the user presses the roller ball 38 to display “email” or “text” buttons 54a, 54b on the screen 36. The roller ball indicator is moved to one of these and the roller ball 38 is pressed, thereby indicating whether an email or text address is to be entered. Whichever one is selected, the appropriate address is entered, using the roller ball to select the corresponding “value” box 52b on the screen 36 and typing in the address using the keypad 34. These steps are repeated for the other addresses to be entered (up to four in the illustrated embodiment). Once the addresses have been entered, the roller ball indicator is moved to the “OK” box 56 and the roller ball 38 is pressed to enter the changes. This stores the information as indicated at 18a, 20 in FIG. 2, and it causes the message to be sent as indicated at 22 in FIG. 2.

While the foregoing example is for a specific implementation, the present invention encompasses other implementations. These include uses and environments mentioned above, for example, and they include different specific features as well. For example, the BlackBerry example refers to a roller ball as a way of making selections; however, others techniques can be used, such as, for example, a touch screen or keystrokes.

Additionally, a particularly preferred embodiment of the present invention is for turning the mobile communication device off when the speed threshold is reached so that no possibly distracting functions of the mobile communication device can occur while the user is driving above the threshold speed. However, it is contemplated and within broader aspects of the present invention to simply disable certain functions of the mobile communication device; therefore, “disabling” the mobile communication device encompasses these whereas “turning off” the mobile communication device specifically addresses the preferred embodiment of total deactivation of the mobile communication device. Examples of disabling functions without turning off the entire mobile communication device include, for example: disabling texting only, disabling voice only, disabling only incoming communications, disabling only outgoing communications, disabling games and other apps only, disabling combinations of these short of the entire mobile communication device. Furthermore, exceptions to the disabling or turning off operations of the present invention may be programmed in, such as, for example: detecting if the mobile communication device is in a hands-free mode (e.g., speaker mode, Bluetooth active, or docking of the device) and then not disabling or turning off the mobile communication device; allowing the mobile communication device to remain enabled for accepting incoming calls or messages from predefined phone numbers or email addresses; allowing use of navigation functions only.

Thus, the present invention is well adapted to carry out the objects and attain the ends and advantages mentioned above as well as those inherent therein. While preferred embodiments of the invention have been described for the purpose of this disclosure, changes in the construction and arrangement of parts and the performance of steps can be made by those skilled in the art, which changes are encompassed within the spirit of this invention as defined by the appended claims.

What is claimed is:

1. Mobile communication device control method, comprising automatically running a usage termination application in a user's mobile communication device for disabling the user's mobile communication device in response to a vehicle moving at a speed greater than a predetermined speed threshold, including: having the user's mobile communication device located in the vehicle, and maintaining the usage termination application solely within the user's mobile communication device such that the speed-responsive disabling of the user's mobile communication device occurs entirely within the existing operations of the mobile communication device alone with no communication of control instructions to or from a network service provider or other party outside the user's mobile communication device.

2. Mobile communication device control method of claim 1, wherein running a usage termination application further includes:
obtaining speed data from the user's mobile communication device;
comparing the obtained speed data with the predetermined speed threshold; and
turning the user's mobile communication device off when the obtained speed data is greater than the predetermined speed threshold.

3. Mobile communication device control method of claim 1, wherein running a usage termination application further includes:
obtaining data related to the locations of the mobile communication device at different times during movement of the mobile communication device; and
turning the mobile communication device off in response to the obtained data representing speed of the vehicle greater than the predetermined speed threshold.

4. Mobile communication device control method of claim 3, wherein obtaining data related to the locations of the mobile communication device includes obtaining data from a global positioning system interface of the mobile communication device.

5. Mobile communication device control method of claim 1, wherein running a usage termination application further includes:
entering a recipient's communication address into the user's mobile communication device; and
sending predetermined messages to the entered communication address in response to predetermined conditions detected by the usage termination application.

6. Mobile communication device control method of claim 5, wherein sending predetermined messages includes detecting when a recipient's communication address is changed in the user's mobile communication device.

7. Mobile communication device control method of claim 5, wherein sending predetermined messages includes detecting when the speed threshold is changed in the user's mobile communication device.

8. Mobile communication device control method of claim 5, wherein sending predetermined messages includes detecting when running the usage termination application is terminated while the user's mobile communication device remains on.

9. Mobile communication device control method of claim 5, wherein sending predetermined messages includes detecting when a global positioning system interface in the user's mobile communication device is not enabled.

10. Mobile communication device control method of claim 5, wherein sending predetermined messages includes detecting when running the usage termination application cannot determine speed of the vehicle.

11. Mobile communication device control method of claim 5, wherein sending predetermined messages includes detecting when running the usage termination application in the user's mobile communication device has started.

12. Mobile communication device control method, comprising automatically disabling at least one communication function of a mobile communication device traveling at a speed greater than a speed threshold, wherein said automatically disabling includes:
automatically determining in the mobile communication device, using a usage termination application stored wholly within the mobile communication device, the speed of the mobile communication device;
automatically comparing in the mobile communication device, using the usage termination application, the determined speed of the mobile communication device to the speed threshold; and
automatically disabling the at least one communication function, using the usage termination application, in response to the determined speed of the mobile communication device exceeding the speed threshold.

13. Mobile communication device control method of claim 12, wherein automatically determining the speed of the mobile communication device includes using in the usage termination application location and time data from elsewhere in the mobile communication device.

14. Mobile communication device control method of claim 12, wherein automatically determining the speed of the mobile communication device includes using in the usage termination application speed data from elsewhere in the mobile communication device.

15. Mobile communication device control method of claim 12, wherein automatically determining the speed of the mobile communication device includes using in the usage termination application location data from outside the mobile communication device, wherein the location data relates to changes in location of the mobile communication device.

16. A method of turning a cell phone off when the cell phone is in a vehicle traveling at a speed greater than a speed threshold, the method comprising:
operating, solely within the cell phone, a usage termination application stored wholly within the cell phone;
entering, by manipulating only the cell phone, user interface configuration options into the usage termination application;
automatically determining in the cell phone, using the usage termination application, the speed of the vehicle;
automatically comparing in the cell phone, using the usage termination application, the determined speed of the vehicle to the speed threshold; and
automatically turning off from within the cell phone, using the usage termination application, the cell phone in response to the determined speed of the vehicle exceeding the speed threshold.

17. A method of turning a cell phone off as defined in claim 16, wherein automatically determining in the cell phone, using the usage termination application, the speed of the vehicle includes receiving into the usage termination application speed-defining data obtained from within the cell phone but from outside the usage termination application.

18. A method of turning a cell phone off as defined in claim 16, wherein automatically determining in the cell phone, using the usage termination application, the speed of the vehicle includes receiving into the usage termination application speed-defining data obtained from outside the cell phone.

19. A method of turning a cell phone off as defined in claim 16, wherein automatically determining in the cell phone, using the usage termination application, the speed of the vehicle includes receiving global positioning system data into the usage termination application.
